(19) United States
(12) Patent Application Publication
(10) Pub. No.: US 2006/0112758 A1
(43) Pub. Date: Jun. 1, 2006

(54) Method for detecting defects in a package containing metal foil by cyclic voltammetry

(75) Inventors: Ku Shang Chang, Hsinchu (TW); Chuan Liang Hsu, Hsinchu (TW)

Correspondence Address: BIRCH STEWART KOLASCH & BIRCH, PO BOX 747, FALLS CHURCH, VA, 22040-0747, US

(73) Assignee: YUANPEI INSTITUTE OF SCIENCE AND TECHNOLOGY

(21) Appl. No.: 11/285,127

(22) Filed: Nov. 23, 2005

(30) Foreign Application Priority Data
Nov. 29, 2004 (TW) 093136751

(51) Int. Cl. G01M 3/04

(52) U.S. Cl. 73/40

(57) ABSTRACT

The present invention relates to a method for detecting defects in a package containing metal foil by cyclic voltammetry, which comprises putting the package into an electrolytic bath, filling electrolyte into the package, positioning one electrode inside the package and positioning the other electrode in the electrolytic bath but outside of the package, then determining the current induced by applying varied voltage, thereby identifying whether the detected defect is a real defect or a pseudo defect. According to the method for detecting defects in a package, it can detect a pseudo defect which could not be detected by conventional electrolytic test.

This Non-provisional application claims priority under 35 U.S.C. § 119(a) on Patent Application No(s). 093136751 filed in Taiwan, Republic of China on Nov. 29, 2004, the entire contents of which are thereby incorporated by reference.

### FIELD OF THE INVENTION

The present invention relates to a method for detecting defects in a package containing metal foil by cyclic voltammetry, particularly to a method for detecting defects in a package containing metal foil by cyclic voltammetry which can detect a pseudo defect which could not be detected by conventional electrolytic test.

### BACKGROUND OF THE INVENTION

The aseptic package is one of the most important packaging types in food industry especially for milk and beverages products. The most important function of an aseptic package is to protect the sterilized product against microbial contamination during storage. Among the factors leading to the deterioration of the packaged products, pinholes caused by failed sealing and/or machinery piecing are the most important ones which may lead to contamination of the product by microorganisms. Therefore, examining techniques for pinhole detecting have been wanted for production of aseptic packaging products.

Conventionally, the acoustic imaging techniques have been used for nondestructive detection of defects in flexible packages. Pleases refer to A. Ozguler, S. A. Morris, W. D. O'Brien Jr., Evaluation of defect in the seal region of food packages using the ultrasonic contrast descriptor, Packag. Technol. Sci. 12 (1999) 161-171; A. A. Safvi, H. J. Meerbaum, S. A. Morris, C. L. Harper, W. D. O'Brien Jr., Acoustic imaging of defect in flexible food packages, J. Food Prot. 60 (1997) 309-314; A. Ozguler, S. A. Morris, W. D. O'Brien Jr., Ultrasonic imaging of micro-leaks and seal contamination in flexible food packages by pulse-echo technique, J. Food Sci. 63 (1998) 673-678; Z. Anhan, Q. H. Zhan, Evaluation of heat seal quality of aseptic food containers by ultrasonic and optical microscopic imaging, European Food Research and Technology 217 (2003) 365-368; and N. N. Shan, P. K. Rooney, A. Ozguler, S. A. Morris, W. D. O'Brin Jr., A real-time approach to detect seal defects in food packages using ultrasonic imaging, J. Food Prot. 64 (9) (2001) 1392-1398. Although channel defects and stand-inclusion defects can be successfully detected by this method, package material containing paper board may disperse too much acoustic energy to provide a reliable imaging medium. Alternatively, the gas leak method could be used to identify leakage by detecting the amount of Helium. This method emphasized the speed of the test and was reported to be able to complete the inspection within 10 seconds (Refer to L. Axelson, S. Cavlin, Aseptic integrity and microhol determination of packages by gas leakage detection, Packag. Technol. Sci. 4 (1990) 9-20). However, this method cannot easily be put into practical use because of its high cost of sealing in Helium gas. The other choice is the immersion bio-test, which has been used to detect pinhole defects by challenging the integrity of a package through microorganisms. Please refer to, for example, S. W. Keller, J. E. Marcy, B. A. Blakistone, G H. Lacy, C. R. Hackney, W. H. Carter Jr., Bioaerosol exposure method for package integrity testing, J. Food Prot. 59 (7) (1996) 768-771 and E. Hurmet, G. Wirtanen, L. Axelson-Larsson, T. Mattila-Sandholm, R. Ahvenainen, Reliability of destructive leakage detection methods for semirigid retort packages, Packag. Technol. Sci. 9 (1996) 203-213; R. Ahvenainen, T. Mattila-Sandlolm, L. Axelson-Larsson, G. Wirtanen, The effect of microhole size and foodstuff on the microbial integrity of aseptic plastic cups, Packag. Technol. Sci. 5 (1992) 101-107; and B. A. Blakistone, S. W. Keller, J. E. Marcy, G. H. Lacy, C. R. Hackney, W. H. Carter Jr., Contamination of flexible pouches challenged by immersion bio-testing, J. Food Prot. 59 (1996) 764-767. A sealed package is put into a solution which contains high concentration of bacteria and holding for a period of time. The package is then placed into an incubator. After a designated time, the package is examined. Through the presence of microorganisms, the integrity of a package can be evaluated. Although the test method is closed to the real situation or even more severe, this method is time-consuming and therefore improper for on-line use.

The dye penetration test has been used for monitoring the integrity of packages by most factories (C. E. Sizer, Method for container testing, in T. B. Dane (ed.), Principles of aseptic processing and package, Vol. 4, CRC Press, Boca Raton, Fla., 1987, 75-77). It is a suitable method for quality control executed in laboratory. However, this method requires a long testing time and the dye may contaminate the environment. Moreover, it is not appropriate to use it on statistical control for the integrity of packages in a packaging line with its high production speed and a strict quantity limit.

The electrolytic test is advantageous in its rapid determination, high sensitivity and cost effectiveness (L. Axelson, S. Cavlin, J. Nordstrom, Aseptic integrity and microhole determination of package by electrolytic conductance measurements, Pack. Technol. Sci. 3 (1990) 141-162; L. Axelson-Larsson, E. Hurme, S. Cavlin, R. Ahvenainen, Leakage analysis of packages by the electrolytic test, Pack. Technol. Sci. 10 (1997) 209-220). However, this test itself is not a conclusive test for laminate-containing-aluminum packages. The electrolytic test mainly comprises charging a fixed voltage to electrodes and determining whether a high current caused by defects such as through hole in the packing material exists. Some of these packages appear a high current during the electrolytic test and are judged to be defect. However it is possible that such a high current is not caused by a through hole but caused by the exposing of the aluminum foil due to breakage of inner plastic film, which do not mean deterioration among the products. Thus, by using the electrolytic test, some packing products only having breakage of inner plastic film but no through hole usually are misjudged as a poor product and thus eliminated. Moreover, the method requires a high power source to provide an 8-10 voltage potential.

Recent trends in research have put increased emphasis on the development of small, portable and battery-operated instruments suited for on-site de-centralized bio-medical and industrial-analysis of sensing systems, for example, C. Wrotnowski, Biosensor technology advances, Genetic Engin. News 2 (1998) 38-41; S. S. Rajinder, Transducer aspects of biosensor, Biosensors & Bioelectronics 9 (1994) 243-264; F. Scheller, F. Schubert, D. Pfeiffer, R. Hintsche, I. Dransfeld, R. Renneberg, U. Wollenberger, K. Riedel, M. Pavlova, M. Kuhn, H. G Muller, P. Tan, W. Hoffmann, W. Movitz, Research and development of biosensors: a review, Analyst 114 (1989) 653-662; and G. Cui, J. H. Yoo, J. S. Lee, J. Yoo, J. H. Uhm, G. S. C. H. Nam, Effect of pre-treatment on the surface and electrochemical properties of screen-printed carbon paste electrodes, Analyst 126 (2001) 1399-1403. An electrochemical instrument would be ideal for this purpose, because electrochemical instrumentation has the potential to be compact, inexpensive, rugged, and versatile (E. Magner, Trends in electrochemical biosensors, Analyst 123 (1998) 1967-1970 and F. Xu, L. Wang, M. N. Gao, L. T. Jin, J. Y. Jin, Amperometric sensor for glucose and hypoxanthine based on a Pd—IrO₂ modified electrode by a co-crosslinking bienzymic system, Talanta 57 (2002) 365-373). Screen-printed electrodes are potentially promising in these aspects because they are economic and easily mass-produced (H. Yamato, T. Koshiba, M. Ohwa, W. Wernet, M. Matsumura, A new method for dispersing palladium microparticles in conducting polymer films and its application to biosensors, Synth. Met. 87 (1997) 231-236; P. Sarkar, E. T. Ibtisam, J. S. Steven and A. P. F. Turner, Screen-printed amperometric biosensors for the rapid measurement of L- and D-amino acid, Analyst 124 (1999) 865-870; J. Wang, V. B. Nascimento, S. A. Kane, K. Rogers, M. R. Smyth, L. Angnes, Screen-printed tyrosinase-containing electrodes for the biosensing of enzyme inhibitors, Talanta 43 (1996) 1903-1907; and M. Albareda-Sirvent, A. Merkoci, S. Alegret, Configurations used in the design of screen-printed enzymatic biosensors-A review, Sensor. Actuat. B 69 (2000) 153-163). The application, of screen-printed sensors is favourable due to some generally claimed advantages such as miniaturisation and easy automation, and for the construction of simple portable device for fast screening purposes and in-field/on-site monitoring (S. V. Dzyadevych, T. Mai Anh, A. P. Soldatkin, N. Duc Chien, N. Jaffrezic-Renault, J. -M. Chovelon, Development of enzyme biosensor based on pH-sensitive field-effect transistors for detection of phenolic compounds, Bioelectro-chemistry 55 (2002) 79-81). In this study, a pair of commercial screen-printed carbon strip (SPCS) was used to detect the integrity of an aseptic laminate package containing aluminum. The main reason for choosing SPCS is its low cost and easily mass-produced.

### SUMMARY OF THE INVENTION

The present invention relates to a method for detecting defects in a package containing metal foil by cyclic voltammetry. The method is capable of distinguishing a metal foil-containing package having no pinhole from that having pinhole.

The present invention relates to a method for detecting defects in a package containing metal foil by cyclic voltammetry, which comprises putting the package into an electrolytic bath, filling electrolyte into the package, positioning one electrode inside the package and positioning the other electrode in the electrolytic bath but outside of the package, then determining the current induced by applying varied voltage and scanning at a constant scanning rate, thereby identifying whether the detected defect is a real defect or a pseudo defect.

### BRIEF DESCRIPTION OF DRAWINGS

The present invention is illustrated more detail by reference to the accompanying drawings, wherein:

FIG. 1 represents a cross sectional view of a laminate package material, in which FIG. 1(A) represents a package material having no defect; FIG. 1(B) represents a package material having a real defect, i.e. a pinhole penetrating through the laminate; FIGS. 1(C) and 1(D) represent package material having a pseudo defect, i.e. damage only on the inner layer;

FIG. 2 represent a schematic view of a cyclic voltammetric (CV) instrument used in the method of the present invention;

FIG. 3(A) represents a cyclic voltammogram for the package material having no defect measured by the method of the present invention; and

FIG. 3(B) represents a schematic view of the CV instrument used for detecting the package material having no defect;

FIG. 4(A) represents a cyclic voltammogram for the package material having pinhole defect measured by the method of the present invention; and FIG. 4(B) represents a schematic view of the CV instrument used for detecting the package material having pinhole defect; and

FIG. 5(A) represents a cyclic voltammogram for the package material having pseudo defects (i.e. the micro-crack only on the inner layer but not penetrating the laminate) measured by the method of the present invention; and FIG. 5(B) represents a schematic view of the CV instrument used for detecting the package material having pseudo defects.

### DETAILED DESCRIPTION OF THE INVENTION

The term “a real defect” used herein means the package material has a defect or pinhole penetrating through the laminate material so that it is possible to allow the external material, such as air, moisture, microbe, etc. entering into the package and then deteriorating the content, such as food, contained therein.

The term “a pseudo defect” used herein means the package material has defects only on its inner layer so that when in using the external material, such as air, moisture, microbe, etc. would not enter into the package and not deteriorate the content, such as food, contained therein.

The method for detecting defects in a package containing metal foil according to the present invention mainly applies varied voltage and detects the induced current thereby determine the defect in the packing material being a real defect or a pseudo defect.

According to the present invention, it mainly comprises cyclic applying a varied voltage in a certain range and measuring the induced current. When the package material to be detected has penetrating pinholes, i.e. a real defect, the induced current is in positive proportion to the size of the pinhole and the applied voltage. If the package material to be detected has cracks only on the inner layer of the package and thus the metal foil is exposed, i.e. a pseudo defect, since metal possesses electron transduction action, the induced current would increase with the applying voltage. But due to the oxidation-reduction potential of metals, after applying voltage, the current induced by the chemical-electrical reaction of metals exhibits a sharp current variation at the oxidation-reduction potential. By detecting the current variation type, it can judge the defect in the package material being a real defect or a pseudo defect.

According to the present method, it can distinguish the pseudo defect detected in conventional electrolytic method and thus can save the packages which are detected being a defect package and should be eliminated in conventional detecting method. Therefore it can more precise to screen the package material and thus save material cost.

The applied voltage in the method for detecting defects in a package containing metal foil by cyclic voltammetry according to the present invention is varied in a certain range depending on the kinds of the metal foil contained in the package material to be detected. However, it is in a range of from −3 to +3 volts, preferably from −2 to +2 volts, more preferably from −1 to +1 volt. Also, the constant scanning rate is several tens per second, for example, from 20 to 80 mV/sec, preferably scanned in a rate of 50 mV/sec. It is possible to determine that the defect to be detect is a real defect or a pseudo defect based on the induced current vibration.

The package material used in the method for detecting defects in a package containing metal foil by cyclic voltammetry according to the present invention can be any package material containing metal foil, preferably a laminate package material containing aluminum foil, more preferably a laminate package material laminated from papers, polyethylene films, aluminum foils in multi layer, most preferably a laminate package material in which the most inner layer is a polyethylene layer, for example, a package material having a composition of polyethylene (PE)/paper/PE/PE.

The present invention is illustrated in more detail by reference the following preferred embodiments which are only used for illustration without limiting the scope of the present invention.

### EXPERIMENTAL EXAMPLE 1

### Materials

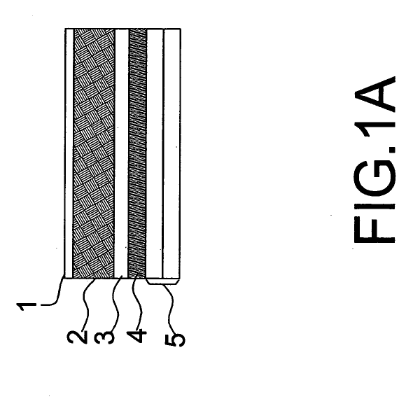

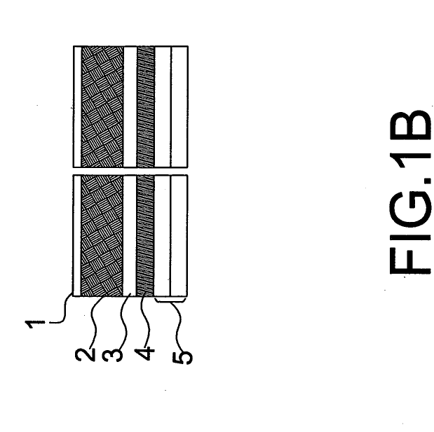

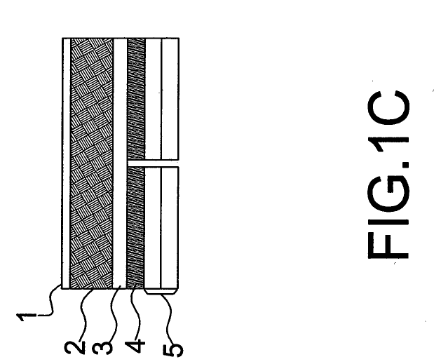

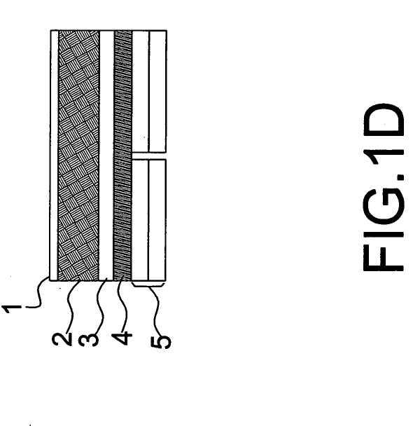

The composition of the packaging material starting from the outer layer was PE/PAPER/PE/ALUMINUM/PE/PE, as shown in FIG. 1.

In the FIG. 1, FIG. 1(A) represents a package material having a composition of PE/PAPER/PE/ALUMINUM/PE/PE and no defects; FIG. 1(B) represents a package material having pinholes caused by failed sealing and/or machinery piecing; FIG. 1(C) and FIG. 1(D) represent a package material having a defect caused by overheating of the sealing area, which leading the crack of the aluminum layer and/or inner plastic layer (called uncompromised packages).

The Rhodamin B, isopropanol, and sodium chloride were purchased from Sigma Chemical Co. (St. Louis, USA). Hydrogen chloride was purchased from Fluka (Seelze, Germany). The dye solution was isopropanol solution containing 1% Rhodium B. The SPCS (Screen Printed Carbon Strip ) was obtained from ApexBichem (Hsinchu, Taiwan).

A total of 90 packages obtained from local market were used to perform the integrity test, the packages have a composition of PE/PAPER/PE/ALUMINUM/PE. Various types of artificial defects were made on the inner surface of these packages. The penetration pinholes were made using honed sewing needles and touch needles with point radius about 2 μm through the package. The crack defects were made using a welding torch and touching needles on the surface of the inner plastic layer for five seconds.

### EXPERIMENTAL SECTION

### Examples

The Detection Method for Cyclic Voltammetry Test

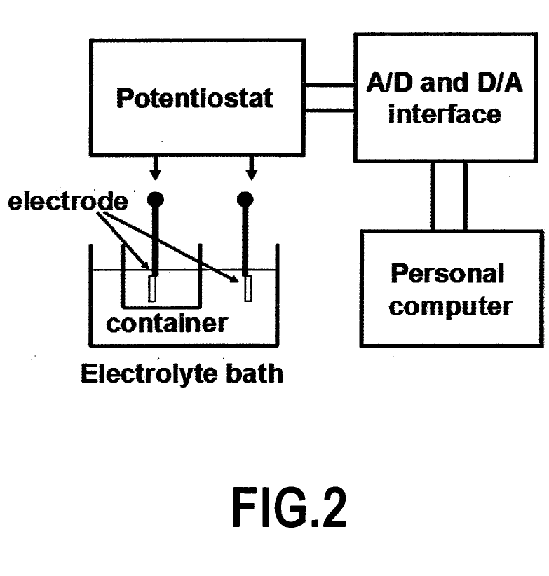

In order to perform the electrolytic test, the package was cut into two halves. The product inside the package was drained out and wiped dry by enforced air. One half of the package was filled with 80 mL of 1% sodium chloride and inserted into an electrolytic bath (dimension: 10×8×5 cm). One screen-printed carbon electrode (2 mm²) was positioned in the electrolytic bath and the other electrode was positioned in the package (as shown in FIG. 2). The cyclic voltammetric (CV) measurements were performed using a laboratory-built potentiostat. Commercial SPCS was used for CV measurements in the experiments. The cyclic voltametric experiments were performed in distilled water in the range between 1 to −1 Volt at a scanning rate of 50 mV s⁻¹. This voltage was selected to give reasonable sensitivity without causing excessive physical and chemical change on the surface of the electrodes. Input and output signals from the potentiostat were coupled to a personal computer (Pentium 600 MHz) using a peripheral interface card (AT-MIO-16E, National Instruments, Austin, Tex., USA). The interface card was consisted of a 16-channel analog-to-digital (A/D) converter (12 bit) and a 2-channel digital-to-analog (D/A) converter (12 bit). Voltage output, data display and resulting cyclic voltammogram ( plot of induced current versus potential) were programmed using the LabVIEW 5.1 software package (National Instruments, Austin, Tex., USA).

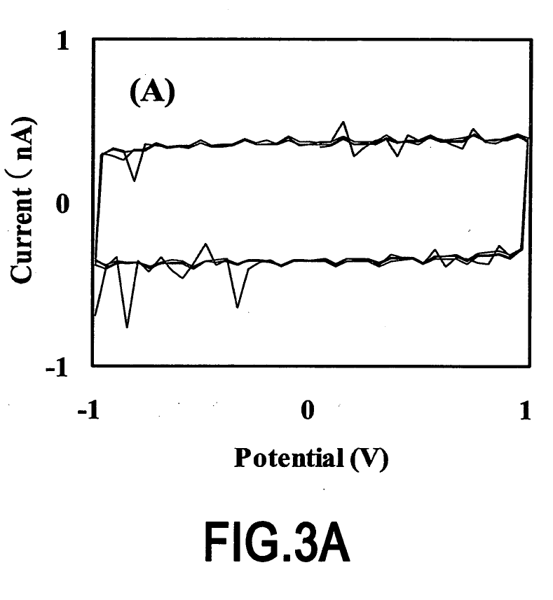

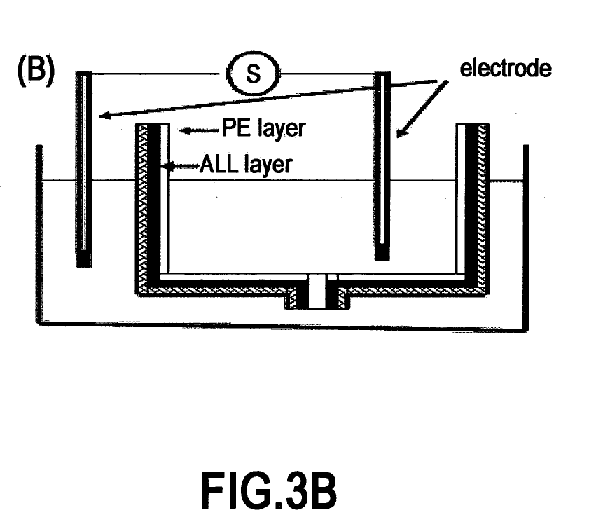

The cyclic voltammogram for the package material having no defect measured by the method of the present invention was shown in FIG. 3(A); and the schematic view of the CV instrument used for detecting the package material having no defect was shown in FIG. 3(B).

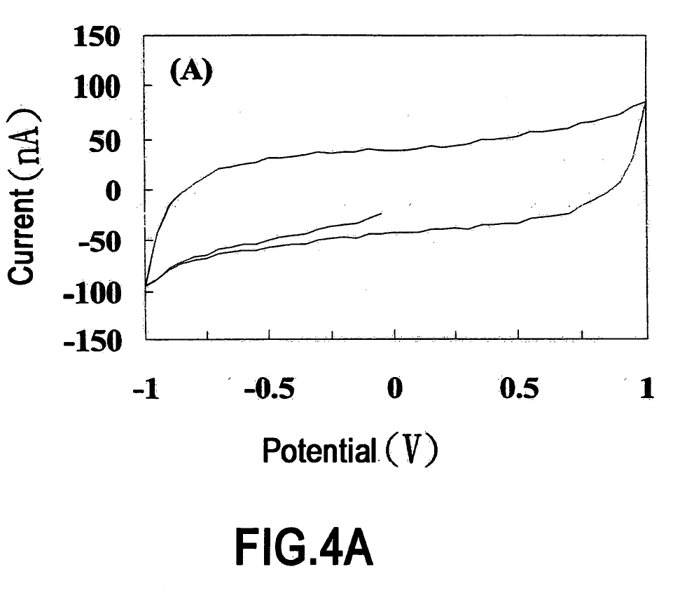

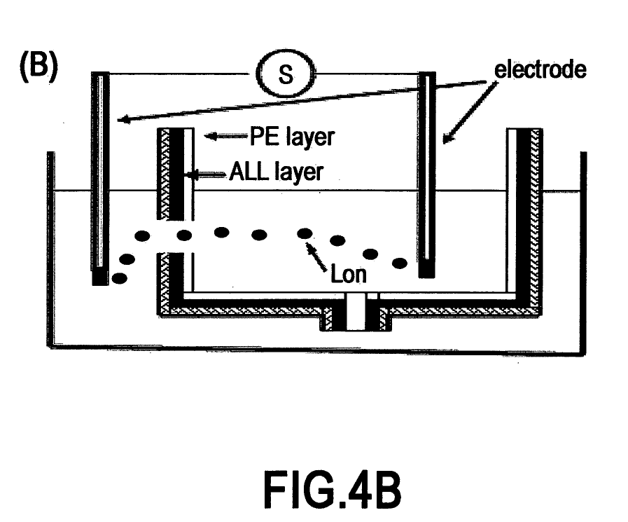

The cyclic voltammogram for the package material having pinhole penetrating the package measured by the method of the present invention was shown in FIG. 4(A); and the schematic view of the CV instrument used for detecting the package material having pinhole penetrating the package was shown in FIG. 4(B).

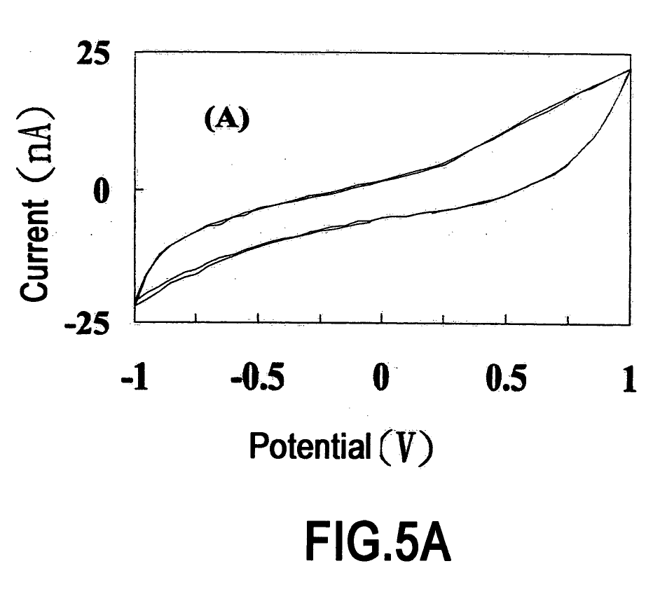

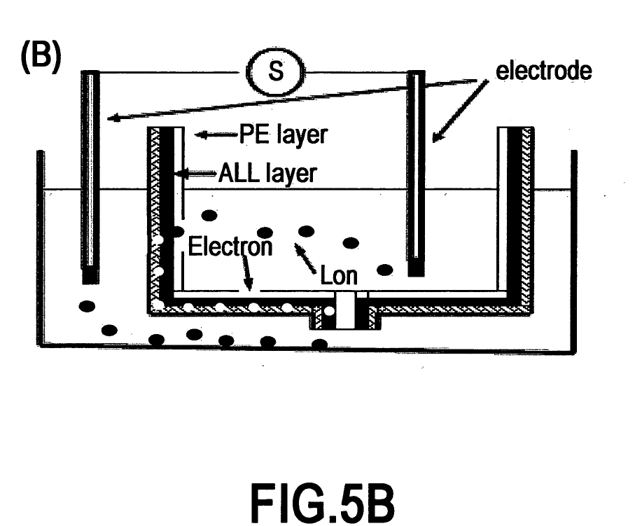

The cyclic voltammogram for the package material having micro-cracks only on the inner layer but not penetrating the laminate measured by the method of the present invention was shown in FIG. 5(A); and the schematic view of the CV instrument used for detecting the package material having micro-cracks only on the inner layer was shown in FIG. 5(B).

### Comparative Examples

Electrolytic Test and Dye Penetration Test

Electrolytic test and dye penetration test have been used for monitoring the integrity of packages by most factories. In this study, the integrity of the package was also tested by the above two methods and the results were compared with the CV method described in the present invention. The electrolytic test was evaluated by detecting the current developed between the two electrodes (diameter: 1 mm, length: 4 mm). Hydrogen chloride (12 M) was added into the package for four hours to demonstrate the presence of cracks on the inner plastic layer, and the package was then inspected under a microscope. Defects in the plastic were confirmed by the presence of small spots in the defect area on exposure of the package to hydrogen chloride. There is a small spot in the defect area because the nude aluminum reacts with the hydrogen chloride. A holding potential of 10 V was applied to the electrode that was placed into the solution inside the package and the current was detected with an amperometer with an accuracy of 0.01 μA.

The dye penetration test was performed after electrolytic test to inspect the leaking situation of the package. A volume of 5 mL dye solution was put into the package. The package was rotated to allow the dye to wet the entire inside circumference of the package and holding for 30 minutes. The package was then inspected to determine whether the package was leaking or not.

If there occurred a large current in the electrolytic test but there was no dye penetration, then hydrogen chloride could be added into the package. If there occurs corrosion due to the reaction between the exposed aluminum with hydrogen chloride, it determined the defect of crack in plastic layer. Thus it could conform that whether cracks are present in the plastic layer but having not penetrated through the package.

### RESULTS AND DISCUSSION

1. Testing of Pack Integrity by Cyclic Voltammetric Method

Voltammetry is a family of techniques with the common characteristics that the potential of the working electrode is controlled (typically with a potentiostat) and the current flowing through the electrode is measured. In one of the most common applications of the technique, the potential is scanned linearly in time; this is called the linear-sweep voltammetry(LV). Cyclic voltammetry (CV) is a linear-sweep voltammetry with the scan continued in the reverse direction at the end of the first scan, this cycle can be repeated a number of times. The cyclic voltammogram was usually used to study the electrochemical behavior of a chemical species at the surface of a bare electrode (K. S. Chang, W. L. Hsu, H. Y. Chen, C. K. Chang and C. Y Chen, Determination of glutamate pyruvate transaminase activity in clinical specimens using a biosensor composed of immobilized L-glutamate oxidase in a photo-crosslinkable polymer membrane on a palladium-deposited screen-printed carbon electrode, Anal. Chim. Acta 303 (2003) 30-38). In the present invention, the method was used to test the integrity of the laminate packages.

When one electrode was positioned in the electrolytic bath, the other electrode was positioned in the package (FIG. 2). The electrodes are isolated by a dielectric material such as polyethylene, a capacitor is formed and the cyclic voltammograms for an integrity package showed rectangular (FIG. 3.). Only small induced current was obtained due to the current flowing through the electrode which was isolated from the polyethylene. In contrast, cyclic voltammograms for package with artificial penetrating pinholes, a larger induced current was detected as shown in FIG. 4. The pinholes performed an ion channel which allowed ion to flow out of the package. The cyclic voltammogram is associated with electrochemical reactions occurring on the carbon strip electrode.

FIG. 5(A) shows the cyclic voltammograms with a micro-crack at the inner layer of the package (uncompromised package) and FIG. 5(B) shows the schematic view of the CV instrument used for detecting the package material having micro-cracks only on the inner layer. The cyclic voltammogram was different from that of penetrating through package. The current was associated with the chemical reaction at the nude aluminum layer. In this case, a peak current between 0.7 and 1.0 volt was observed (FIG. 5A) that was due to the chemical reaction at the nude aluminum layer when the potential was larger than 0.7 volt. The electrical current is passed trough an electrolytic cell and oxidation reactions occur at the aluminum layer. By the cyclic voltammograms method according to the present invention, defective of penetrating package (real defect) or micro-crack at the inner layer (pseudo defect) can be identified. The results are shown in Table 1.

2. Testing of Pack Integrity by Electrolytic Measurement and Dye Penetration Method

The electrolytic measurement is based on the principle that a tight plastic container is an electrical insulator. By introducing an electric potential across a brine-filled package which is partially immersed in a brine solution, integrity can be determined if any holes exist in the package. Any defect in the package which allows current to flow out of the package results in a defective package. The passage of current indicated the possibility of a package defect. The results are shown in Table 1.

TABLE 1
The number of package having defect measured
by various detecting method (%)^{a)}

| | | | cyclic voltammetric |
|---|---|---|---|
| | Electrolytic | Dye penetration | method (the present |
| | test^{b)} | method | invention) |
| integrity | 0(0%) | 0(0%) | 0(0%) |
| packages^{b)} | | | |
| artificial | 30(100%) | 0(0%) | 3(10%) |
| penetration | | | |
| packages^{c)} | | | |

Note:
^{a)}The percentage in parenthesis means the ratio of the number of package having defect to the total detected package.
^{b)}30 Packages in total were detected.
^{c)}Threshold current for the package greater than 100 μA when applying a constant potential 10 Volt to platinum electrode was identified as defects.

Table 1 shows the pinhole determination of artificial defective package by electrolytic measurement, dye penetration test. and the present CV method. By electrolytic measurement, threshold current for the package greater than 100 μA was identified as defects. By dye penetrating test, the dye leaking out was identified as defects. By the present CV method, a peak current observed between 0.7 and 1.0 volt was identified as defects. It shows almost the same results by these methods for integrity packages and artificial penetration packages.. Most of new flexible packages are laminates made of various combinations of paper, aluminum foil and plastic. The product contact surface is polyethylene (PE). The PE layer is backed by an additional layer of PE and which is bonded to the aluminum foil layer. The next layer of polyethylene bonds the aluminum is the paper layer which is used for container rigidity and the printed graphics. An outer layer of polyethylene serves to protect the paper from moisture. There are two kinds of defects which cause the current developing between the two electrodes when the electrolytic measurement was conducted. The first category is pinholes caused by failed sealing and/or machinery piecing (FIG. 1B). The pinholes allow ions or dye to flow out of the package. Thereby the artificial penetration packages were detected as defects by any of these methods. The second category is defect caused by overheating of the sealing area (FIGS. 1(C), 1(D)), which leading the crack of the aluminum layer and/or inner plastic layer (called uncompromised packages). The nude aluminum acted as an electric bridge. Table 1 shows the difference results among electrolytic test, dye penetration test and CV method for artificial uncompromised packages. By electrolytic measurement, all of the packages detected were found to be defect. However, no package was identified to be defects by the dye penetration test. The result shows that the traditional electrolytic measurement in itself is not a conclusion test for this kind of package since there are possible for defective results to come from tight containers. Several packages even developing a current more than 1000 μA during the electrolytic measurement, yet no leakage was found by dye penetrating. In the present CV method, 90% with total of 30 packages were obtained a peak current between 0.7 and 1.0 volt as presented in FIG. 5A. It can be concluded that there are micro-cracks exist at the inner layer of these packages which are identified as defects. Only 10% of the packages were identified as pinholes existed. The present CV method could save 90% of the packages which were identified as leaking by using the electrolytic measurement. The method can identify pinholes arising from crack defects in the plastic inner layer of a laminate package containing aluminum.

By traditional electrolytic measurement, the penetrating pinholes through the package and crack defects of the plastic inner layer of a package can not be distinguished owing to the high current would be detected in a penetrating package. However, the cyclic voltammetry method is applicable to distinguish between these two different types of defects. The present CV method is also advantageous in rapid determination, high sensitivity, cost effectiveness and does not contaminate the environment like the dye penetration method.

### EFFECTS OF THE INVENTION

In statistical control, a package with penetrating micro holes is considered as a critical defect, which will lead to the penetrating of microorganism into the package. However, an uncompromised package is considered as a minor defect, microorganism cannot penetrate through the aluminum layer. The integrity of a package is essentially accepted. The only problem must take into account is the interaction of the product and the nude aluminum.

The cyclic voltammetry method according to the present invention can distinguish the penetrating micro-holes through the package and the crack defects of the plastic inner layer of a package. However, these two different types of defects can not be distinguished by traditional electrolytic test since a high current can detected in the uncompromised package as well as detected in a penetrating package.

From the above, the cyclic voltammetry method according to the present invention has shown to be a rapid conclusive test-method for the determination the integrity of the laminate packages.

What is claimed is:

1. A method for detecting defects in a package containing metal foil by cyclic voltammetry, which comprises putting the package into an electrolytic bath, filling electrolyte into the package, positioning one electrode inside the package and positioning the other electrode in the electrolytic bath but outside of the package, then determining the current induced by applying varied voltage and scanning at a constant scanning rate, thereby identifying whether the detected defect is a real defect or a pseudo defect.

2. The method according to claim 1, which is used for distinguishing a defect penetrating the package from the defect of crack only on inner layer of the package.

3. The method according to claim 1, wherein if there is a sharp current variation in the induced current at a certain voltage, it determines the package has a defect only on the inner layer of the package.

4. The method according to claim 1, wherein the varied voltage is in the range of from −3 to +3 volts.

5. The method according to claim 1, wherein the scanning rate is from 20 to 80 mini-volts per second.

6. The method according to claim 1, wherein the package containing metal foil is a package containing aluminum foil.
